(19) United States
(12) Patent Application Publication
(10) Pub. No.: US 2018/0068588 A1
(43) Pub. Date: Mar. 8, 2018

(54) Instrument Landing System (ILS) Localizer and Glideslope Simulator Training Stations using GPS and LASER Position Identification for Active Antenna Feedback and Radiation Pattern Simulation

(71) Applicant: Scott Lee Williams, Sallisaw, OK (US)

(72) Inventor: Scott Lee Williams, Sallisaw, OK (US)

(21) Appl. No.: 15/260,045

(22) Filed: Sep. 8, 2016

(51) Int. Cl. G09B 23/18

(52) U.S. Cl. CPC G09B 23/187; H04W 88/04

(57) ABSTRACT

Instrument Landing System (ILS) Localizer and Glideslope Simulator Training Stations using GPS and LASER Position Identification for Active Antenna Feedback and Radiation Pattern Simulation is designed to provide complete training for ILS maintenance technicians using a unique combination of hardware and software. GPS and LASER modules embedded in simulated antennas define the physical position of the antennas and custom software coverts that position along with adjustable transmitter and RF Power, Modulation, and Phase distribution settings into a wireless digital data stream that emulates an actual ILS signal when viewed in the field by a custom designed simulated ILS field receiver. The overall system is monitored and controlled through a central processor. Simulated test equipment is provided to measure field readings and transmitter settings.

### CROSS-REFERENCE TO RELATED APPLICATIONS

This application claims the benefit of applicants' prior provisional patent, application No. 62/217,793 bearing the same title filed on Sep. 11, 2015.

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

The Instrument Landing System (ILS) is a standard radio navigational aid used worldwide for decades to aid pilots when landing aircraft. The primary components of an ILS are the Localizer which provides horizontal guidance and the Glideslope which provides Vertical guidance. While hardware may vary based on equipment versions and manufacturers, the basic principles and hardware configurations required to produce an ILS output are public knowledge. Numerous documents available through the Federal Aviation Administration, Educational Institutions, and Equipment Manufacturers describe the operation of ILS equipment. This invention has been devised as a realistic and precise method to train maintenance technicians on Instrument Landing System (ILS) operation and maintenance tasks through simulation.

Training for specialists who maintain ILS equipment is commonly conducted either by instructors using actual transmitting equipment or through simulations that do not provide realistic training in the areas of antenna radio signal propagation. The use of ILS transmitting equipment at a dedicated training location is expensive. It requires a comprehensive hardware package, extensive installation design for each location, availability of considerable acreage to produce the field signal, has no portability, needs constant maintenance, and requires an FCC transmit frequency authorization for each equipment item. The use of active ILS equipment at airports for training causes interruption to services used by aircraft and can result in damage to the operating equipment. The use of active equipment can impact the flying public because the normal ILS service is unavailable while the equipment is used for training.

The use of simulation only training lacks realistic interaction with the most important equipment; the antennas that produce a radiation pattern, the distribution unit that sets up the radiated signal, and the integral monitor circuits that represent field radiation.

This invention will provide a portable, inexpensive, and realistic hands-on training option that can support training activities related to both hardware and radiation pattern without any impact to actual equipment or airport operations.

### BRIEF SUMMARY OF THE INVENTION

This patent application is for a training simulator that emulates the equipment operation and radiated environment of Instrument Landing System (ILS) Localizer and Glideslope Systems. This simulator is used to train ILS maintenance technicians in the installation, operation. repair, and maintenance of ILS systems.

This invention includes hardware that simulates antenna operation and position, hardware that simulates transmitting equipment operation, hardware that simulates monitoring equipment operation, and hardware that simulates ILS test equipment.

This invention includes software that evaluates simulated antenna position data, simulated transmitter hardware data, and simulated antenna system data to create a simulated ILS radiation pattern and monitoring image that can be evaluated from both the transmitter and radiated field perspective.

This invention creates a wireless data stream that can be interpreted as an ILS radiation pattern when using the included simulated test equipment. Changes in simulated antenna placement, simulated ILS power levels, simulated ILS modulations, or simulated ILS signal phase will result in corresponding changes in the simulated radiation pattern just as in the case of an actual ILS.

This invention is unique in that it not only simulates the ILS transmitter and monitor operation but also provides measurable field changes as seen by the ILS receiver simulated test equipment proportional to those expected in an ILS when antenna positions or transmit features are changed. This invention cannot be used by aircraft for navigation and does not operate on any frequency that falls within the aircraft aviation band.

### BRIEF DESCRIPTION OF THE SEVERAL VIEWS OF THE DRAWING

FIG. 1 is an Overall Block Diagram of the Simulated Localizer Equipment

FIG. 2 is a Block Diagram of the Simulated Localizer Antenna Unit

FIG. 3 is a Block Diagram of the Simulated Localizer Transmitter/Distribution/Recombining (TDR) Unit

FIG. 4 is a Block Diagram of the Simulated Localizer Central Processor and Wireless Unit

FIG. 5 is a Block Diagram of the Simulated Localizer Field Receiver

FIG. 6 is an Overall Block Diagram of the Simulated Glideslope Equipment

FIG. 7 is a Block Diagram of the Simulated Glideslope Transmitter/Distribution/Recombining (TDR) Unit

FIG. 8 is a Block Diagram of the Simulated Glideslope Central Processor and Wireless Unit

FIG. 9 is a Block Diagram of the Simulated Glideslope Antenna Unit

FIG. 10 is a Block Diagram of the Simulated Glideslope Field Receiver

### DETAILED DESCRIPTION OF THE INVENTION

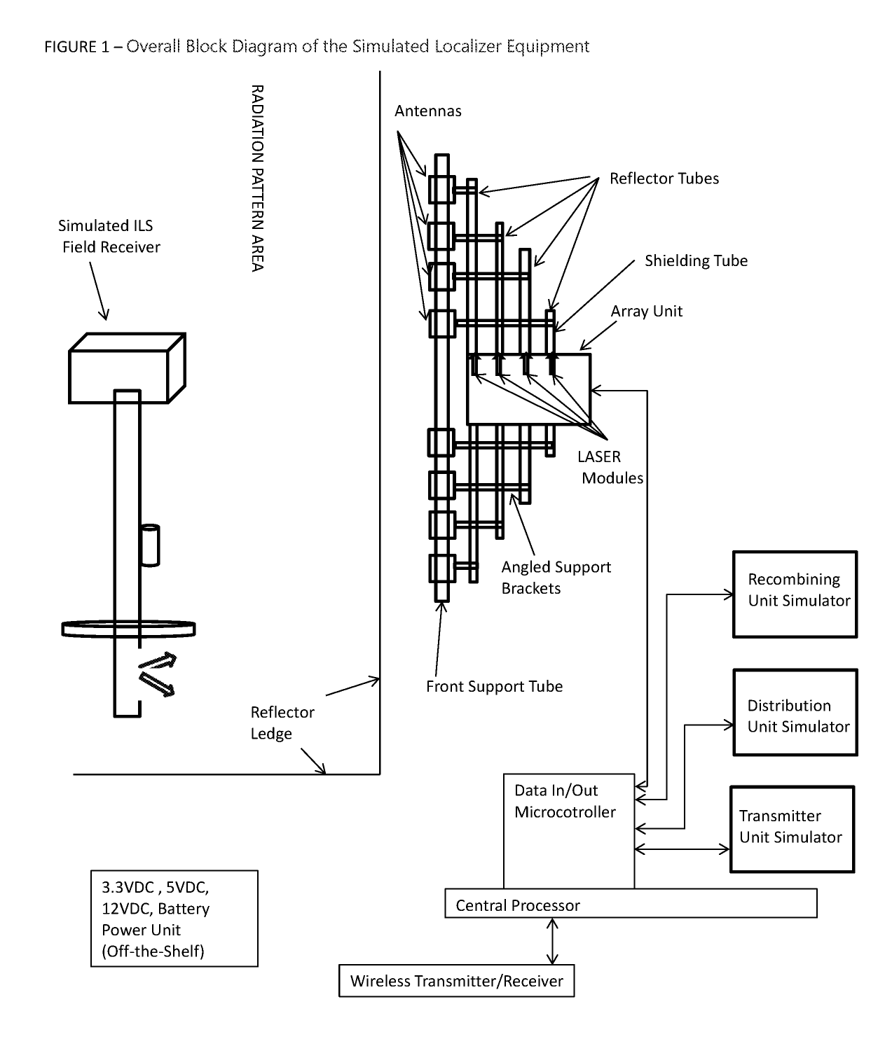

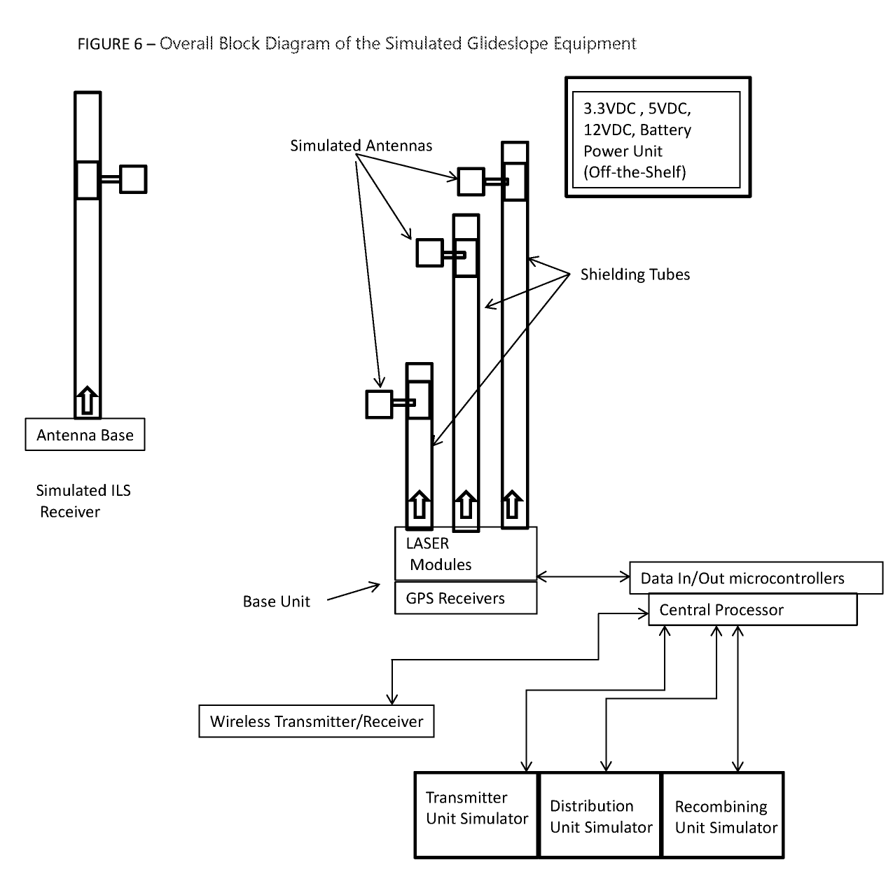

This invention is comprised of simulated antenna arrays, simulated transmitter/distribution unit/antenna recombination (TDR) units, simulated monitoring via software and computer display, simulated test measurement equipment, simulated Field ILS receivers, wireless transmitter/receiver units, and a custom software program operating on a central computer. The software interprets antenna position and transmitter configuration to produce a wireless data stream that is interpreted as an ILS radiation pattern when viewed with the simulated ILS receiver in front of the antenna array. The custom software also creates a monitored representation of the simulated radiation pattern based on transmitter, antenna, and recombining unit settings. Localizer (FIG. 1) and Glideslope (FIG. 6) operation are simulated and both sets of equipment use a similar design.

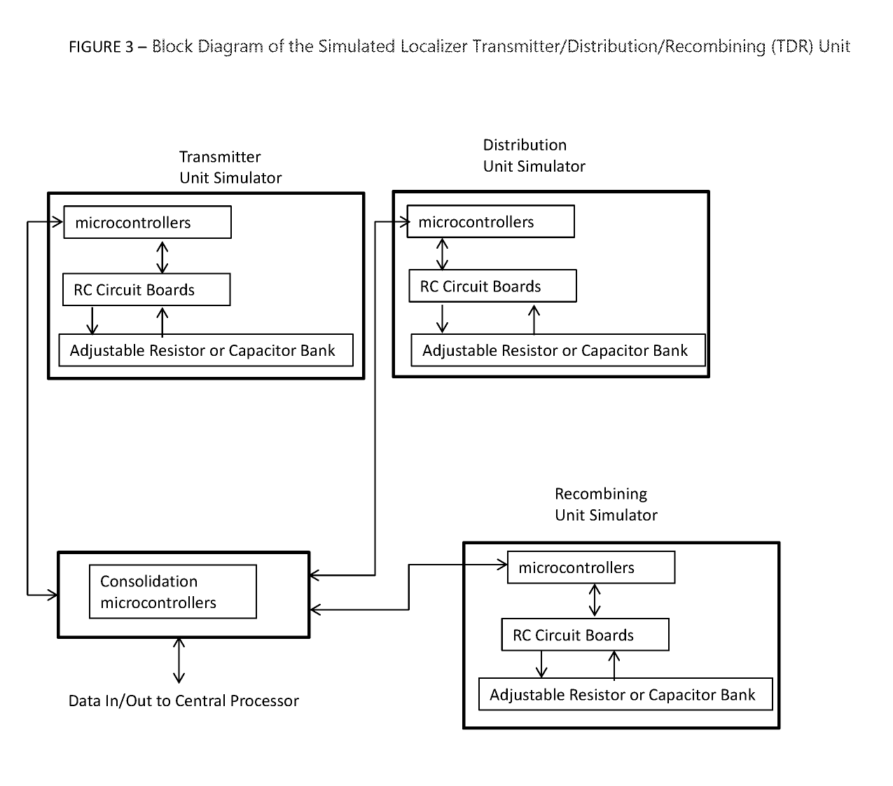

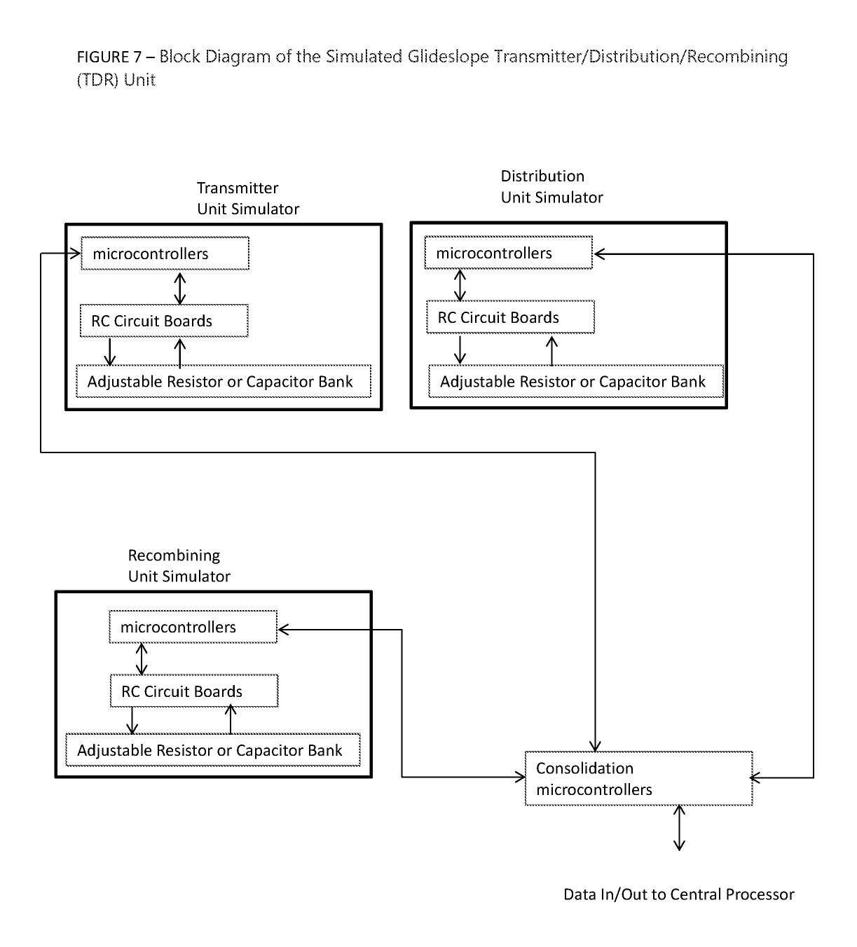

The simulated transmitter/RF Distribution/Recombination (TDR) Units (FIG. 3 and FIG. 7) are comprised of a series of adjustable Resistive/Capacitive (RC) circuits attached to microcontrollers. Each RC circuit representing a data point is wired to a dedicated microcontroller that charges the capacitor and measures the discharge time through the resistor in order to create a numeric value that can be scaled and applied as a parameter data value. The RC combination is adjustable to create simulated adjustable parameter values (data) used in calculations for RF Power, Modulations, and Phase settings. Software options can bypass the RC adjustments or create a reference baseline value for each parameter that can be varied by the RC adjustments. These parameter values are organized within microcontroller circuits and combined as a data stream output which is sent to a central processor to contribute to the creation of a radiation pattern and monitoring image. Changes to the TDR units provide a proportional influence on the simulated monitoring circuits. The number of TDR units used in the Localizer or Glideslope simulator system is determined based on selection of a single or dual transmitter configuration and selection of single or dual frequency configuration.

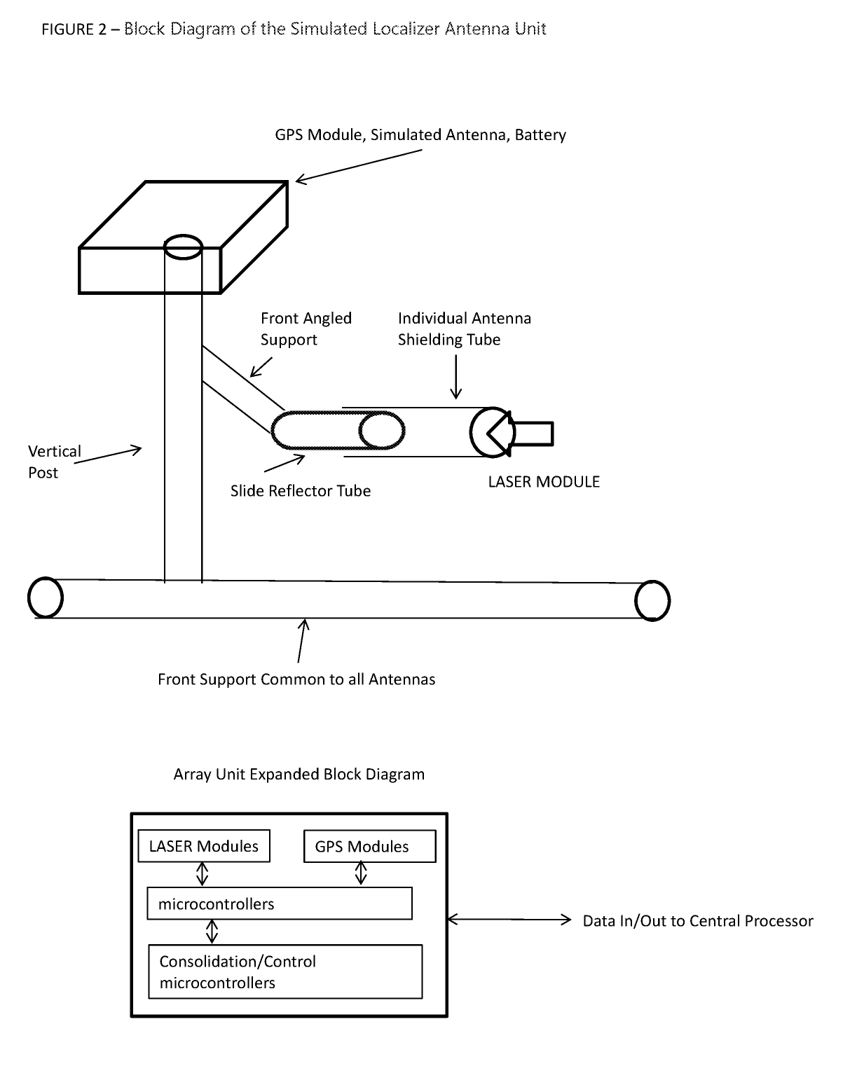

The simulated Localizer antenna array (FIG. 1 and FIG. 2) is comprised of simulated antenna units, an array unit, a front slide tube, a reflector tube, and shielded connecting tubing. Each simulated antenna unit contains a GPS receiver that is connected to the array unit. The physical appearance of the simulated antennas is irrelevant to operation as they provide no actual transmit signal. The simulated antennas are arranged in a straight line extending from the antenna array unit connected to the array unit by rigid tubing. All simulated antennas across the array are connected by vertical tubes to a common front slide tube at ground level in a manner that allows the simulated antennas to slide along the tube closer or further from the array unit. Each individual simulated antenna is also supported by a rear angled vertical tube that is connected to a horizontal reflector tube section at ground level at the rear of the antenna. The horizontal reflector tube for each antenna slides into a shielding tube to connect the simulated antenna the array unit. Antenna horizontal reflector tubing outside diameter is slightly smaller than shielded connecting tubing inside diameter in order to allow the antenna horizontal reflector tubing to slide within the shielding tubing and move the antenna closer or farther from the array unit. The array unit contains a LASER measurement device for each antenna shielding tube and tracks the distance from the array unit to each moveable antenna in order to define the relative physical location of the antennas. The LASER units in the array unit provide a serial data output to dedicated microcontroller modules which then send a consolidated serial data stream to a central processor (computer) for use in radiation pattern and monitoring calculations. Movement of any antenna will result in corresponding changes to the central processor calculation of the image of the radiation pattern. LASER measurements are accomplished through shielding tubing to prevent sunlight interference and reduce personnel hazards. Reflectors discs are attached to the ends of the antenna horizontal reflecting tubes to increase distance reading stability. In an alternate configuration one distribution tube is used on each side of the array for all antennas on that side and reflectors at each antenna position are electrically activated for measurement by a single LASER. The number of simulated antenna units and associated hardware is based on the desired Localizer configuration. The eight element single frequency simulated antenna array is the basic configuration and extended configurations are available to simulate single or dual frequency operation.

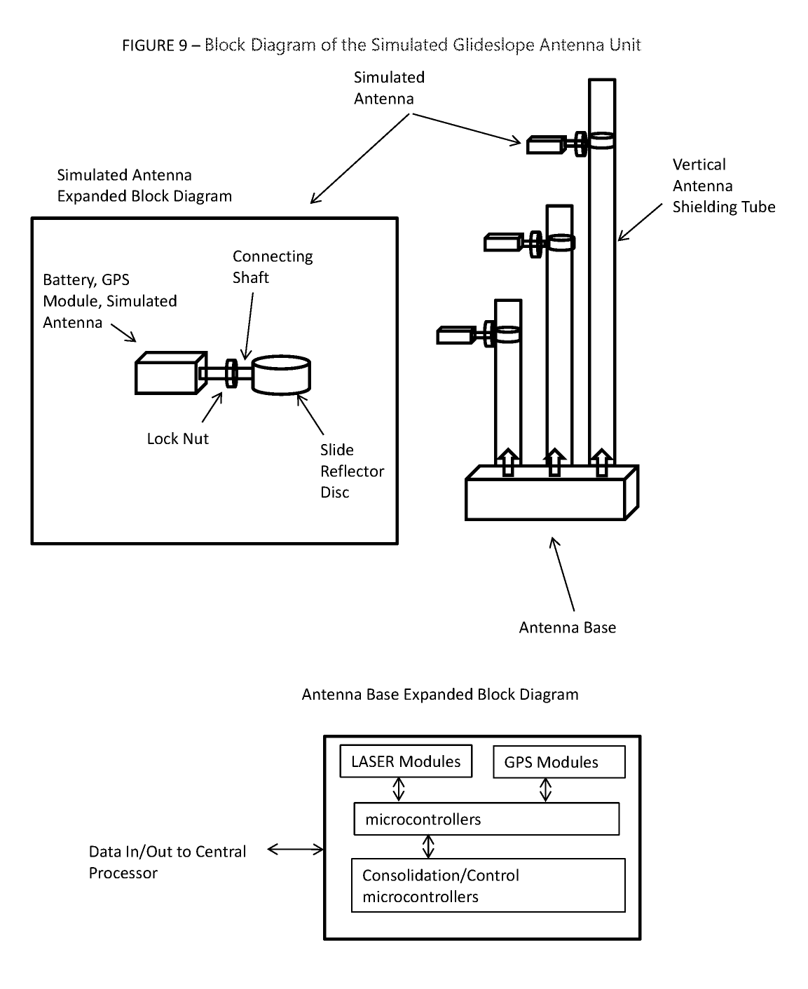

The simulated Glideslope antenna array (FIG. 6 and FIG. 9) is comprised of simulated antenna units and a base unit. Each antenna unit is comprised of a simulated antenna unit, a reflector tube, a connecting shaft with a lock nut, and a vertical shielding tube having slots cut in place along the length of the tube. The physical appearance of the antennas is irrelevant to operation as they provide no actual transmit signal. Each simulated antenna may contain a battery unit, GPS unit, and wireless transmitter/receiver to aid in calculating antenna heights. Antenna unit shielding tubes extend vertically from the base unit and each tube houses one antenna. A short reflecting tube with an outside diameter slightly smaller than the inside diameter of the shielding tube is inserted in the shielding tube. A connecting shaft is placed from the reflecting tube through the slot in the shielding tube to the simulated antenna. A lock nut on the connecting shaft secures the simulated antenna to the height determined by the user. A disc reflector is attached to the bottom of the reflector tube. The simulated antenna attached to the reflector tube can slide vertically in the shielding tube slot moving the reflector and creating a means to change antenna height when measured by the LASER measurement device at the base of the antenna. The antenna base is comprised of GPS modules, LASER Modules, and microcontrollers. One LASER is required for each antenna unit to determine simulated antenna height. LASER measurements are accomplished through vertical shielding tubing to prevent sunlight interference and reduce personnel hazards. Disc reflectors are attached to the reflector tube to increase height reading stability Multiple GPS modules are used to average the reading and define antenna position. The embedded GPS and LASER units in the antenna base provide a serial data output to dedicated microcontroller modules which then send a serial data stream to a central processor for use in radiation pattern and monitoring calculations. Movement of any antenna will result in corresponding changes to the central processor calculation of the image of the radiation pattern. The antenna units are approximately three to 10 feet long and an offset is added to height calculations in order to simulate an actual antenna height which could range up to 60 feet. Use of the shorter antennas with offset added to calculations increases usability and reduces safety issues.

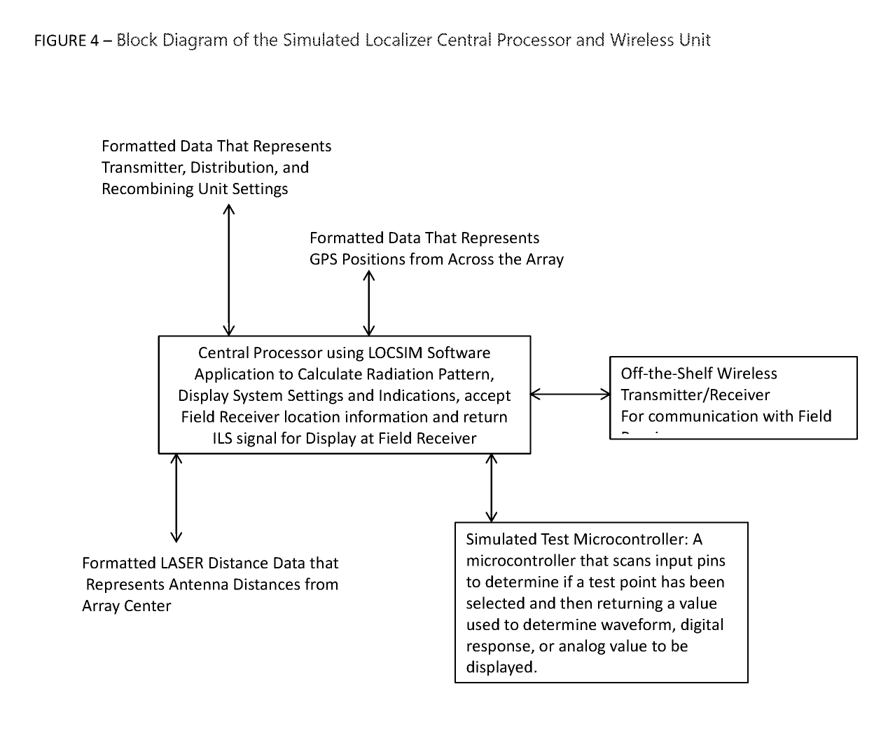

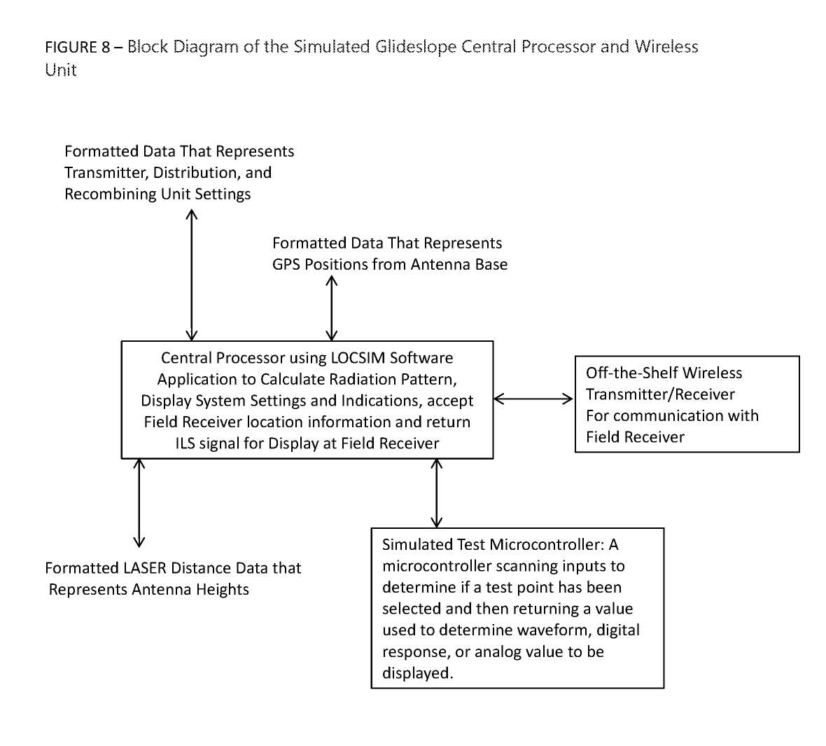

The central processor (FIG. 4 and FIG. 8) is comprised of an off the shelf computer with a display monitor, custom software, communication microcontrollers, and a test emulator microcontroller. The simulated Localizer and simulated Glideslope each have one central processor. The central processor accepts antenna position parameters, transmitter parameters, and RF Distribution Unit parameters from microcontrollers to calculate anticipated ILS radiation pattern readings at each degree point in front of the antenna array for the Localizer or calculated anticipated ILS radiation pattern readings at different elevations for the Glideslope. At any given time an image of the radiation pattern exists in the central computer that is based on transmit, distribution, and antenna circuit simulated settings. The central processor software can then communicate that image to the Simulated Localizer or Glideslope Field ILS Receiver through a wireless data transceiver unit. Simulated test points are provided at the central processor unit to select simulated signal waveforms, frequencies, and power. A test lead is attached to the central processor and loops back a ground to the simulated test microcontroller. The test microcontroller senses when a connection is made to a specific input and then returns a definition of the parameter identified in software which is then represented on the central processor display. These indications will shift when adjustments are made to the transmitter/distribution /recombining unit in the same manner as test equipment connected to an actual ILS. The central processor software includes a simulated integral monitor mode that provides monitoring indications based on the simulated antenna pattern data and user settings in the RF Recombining inputs. The software at the central processor is a custom package based on a program titled LOCSIM.

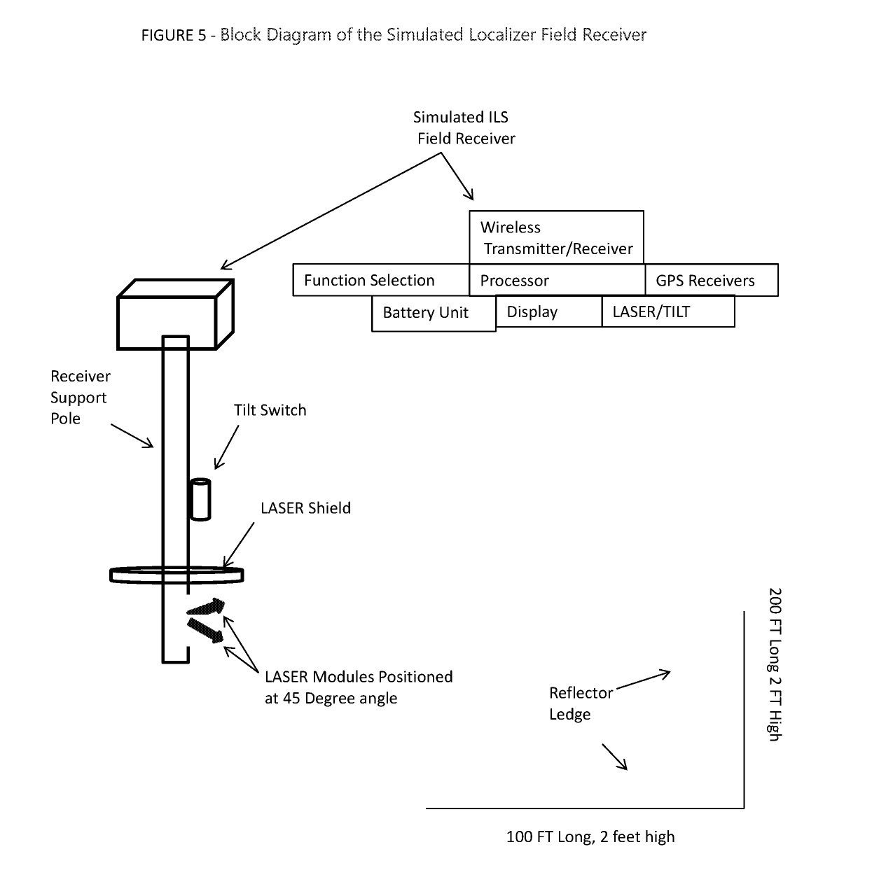

The Simulated Localizer Field ILS Receiver (FIG. 5) is a specially designed processing unit comprised of GPS receivers, LASER positioning devices, a horizontal LASER shield, a pole tilt switch, a display section, a selection section, wireless transmitter/receiver, battery unit, computer processor, and custom software. The Simulated Localizer Field ILS receiver will determine its' measured horizontal angular physical position in relationship to the center of the simulated Localizer antenna array through the use of multiple GPS receiver data, LASER distance measurements to a fixed reflector ledge, or a combination of the two. The reflector ledge is two foot high vertical reflective surface that extends in front of and on one side of the 100 feet by 200 feet radiation area. The simulated Localizer Field Receiver is mounted on a pole that has two LASER devices, one pointed in front of the simulated Localizer field receiver and one at 90 degree angle to the side. This allows the LASER devices to measure distance to the reflector ledge front and side and calculate the angular position from the center of the simulated Localizer antenna array. This data will be used by the off-the-shelf computer processor to calculate the physical position of the simulated ILS receiver with respect to the simulated Localizer antenna array. The Simulated Localizer Field ILS receiver will transmit its' angular position through a wireless transceiver to the simulated Localizer central processor and the simulated Localizer central processor will respond with the anticipated ILS signal pattern image for that particular position. Using data from the simulated Localizer central processor the simulated Localizer Portable ILS receiver will display the ILS signal pattern image for its location. The Simulated Field ILS Receiver displays modulations or RF Power levels based on user selection. A vertical LASER shield is mounted above the LASERS to reduce unwanted sunlight and a tilt switch is attached to the pole to shut off the LASERS if the pole is not upright. The tilt switch is a personnel safety device.

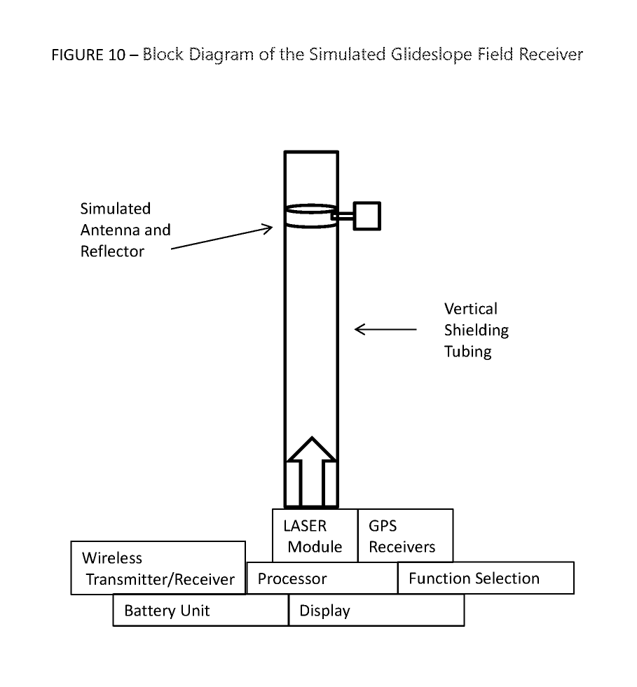

The Simulated Glideslope Field ILS Receiver (FIG. 10) is a specially designed processing unit comprised of GPS receivers, LASER positioning devices, wireless transmitter/receiver, a display section, a selection section, a vertical shielding tube, a simulated antenna, a processor, battery unit, and custom software. The Simulated Glideslope Field ILS receiver will determine its' antenna vertical angle relative to the simulated Glideslope antenna base and display radiation characteristis based on user selection. The angle measurement is a result of distance values acquired by averaging GPS data at the simulated Glideslope antenna base and simulated Glideslope Field Receiver base and the LASER determined height of the Glideslope Field Receiver antenna. LASER height of the simulated Glideslope Field Receiver is measured from the base of the unit through a shielding tube to a fixed reflector attached to an adjustable simulated Glideslope Field Receiver antenna. The Simulated Glideslope Field ILS receiver processor will transmit its' height and location through a wireless transceiver to the simulated Glideslope central processor and the central processor will respond with the anticipated ILS signal pattern data image for that particular position. The simulated Glideslope Field ILS receiver will display the ILS signal pattern data image for its location. The Simulated Field ILS Receiver will be able to display modulations or RF Power levels based on user selection.

The total package creates an ILS Equipment environment that can be evaluated and changed from both the transmit and radiated field perspective. Power levels, RF Phase, Frequency, and Modulations will be adjustable and measurable. Radiation pattern indications will be available in an area approximately 150 by 200 feet and will replicate an ILS radiation pattern when measured by the simulated portable ILS receiver for the simulated Localizer. Radiation pattern indications will be available at a 30 foot measurement mast and will replicate a Glideslope radiation pattern when measured by the simulated portable ILS receiver.

This invention is unique in that it not only simulates the ILS operation through software but also provides measurable changes in the field and monitoring proportional to those expected in an ILS when transmit or antenna parameters are changed. This happens without actually transmitting an ILS signal. Antenna position is critical in the operation of ILS equipment and there are no training solutions available that provide a complete ILS training environment without the use of actual radiating equipment. This invention is unique as well because it uses a wireless digital data stream on a non-aviation frequency band to provide data that can be interpreted as an ILS signal with when using a simulated ILS receiver.

The student will use this invention in conjunction with laboratory exercise manuals in order to learn and experiment with the ILS equipment and radiation field. This simulator will allow for instruction of both antenna and ILS theory and application. It can also be used to test proficiency in troubleshooting, basic maintenance procedures, and flight inspection activities. Scenarios can be programmed into the central processor to create troubleshooting and technician proficiency tests.

1. A Instrument Landing System (ILS) Localizer antenna array simulator being comprised of simulated antennas, GPS receivers that identify individual and overall array antenna positions, LASER devices sending light through tubing to reflectors that identify individual antenna positions, a microcontroller that reads antenna position information and supplies antenna position information to computer processing equipment.

2. An Instrument Landing System (ILS) Localizer Transmitter/Distribution/Recombining (TDR) Unit simulator being comprised of multiple adjustable electronic circuits, each using a resistance and capacitance pair connected to a microcontroller which charges the capacitor and measures the discharge time through the resistor and converts the discharge time to a scalable number that represents parameters including simulated RF Power for Carrier plus Sidebands (CSB), simulated RF Power for Sideband Only (SBO), simulated 90 Hz Modulation, simulated 150 Hz Modulation, simulated Identification tone Modulation, simulated Audio Phase, Simulated Individual Antenna Output Power and Phase Levels, Simulated Antenna individual and combined monitoring Input Power and Phase levels, simulated test points, and simulated CSB to SBO Phase.

3. An Instrument Landing System (ILS) Localizer simulated radiation pattern central processing unit comprised of off the shelf computer hardware, a consolidation microcontroller that accepts the outputs of simulator circuits identified claims 1, and 2, custom software that produces an image of the current Localizer operation using Localizer transmitter, distribution unit, and antenna simulator data from the simulator circuits identified in claims 1 and 2, a wireless interface connected to the processor that communicates with a simulated field ILS receiver in order to acquire the angular position of the receiver and then supply a calculated radiation pattern reading back to the simulated ILS receiver position, an internal monitoring custom software feature that represents the internal monitoring of the system using data from the outputs of simulator circuits identified in claims 1, 2, and the settings in the central processor, and a user interface that allows control and viewing of the overall simulator operation.

4. A Instrument Landing System (ILS) Glideslope antenna array simulator that emulates the ILS Glideslope antenna behavior being comprised of simulated antennas, GPS receivers that identify individual antenna positions, LASER devices sending light through tubing to reflectors that identify individual antenna heights, and a microcontroller that reads antenna position information and supplies antenna position information to computer processing equipment.

5. An Instrument Landing System (ILS) Glideslope transmitter/Distribution/Recombining simulator comprised of multiple adjustable electronic circuits, each using a resistance and capacitance pair connected to a microcontroller which charges the capacitor and measures the discharge time through the resistor and converts the discharge time to a scalable number that represents parameters including simulated RF Power for Course Carrier plus Sidebands (CSB), simulated RF Power for Course Sideband Only (SBO), simulated Course 90 Hz Modulation, simulated Course 150 Hz Modulation, Simulated Clearance 150 Hz Modulation, simulated Audio Phase, simulated Individual Antenna Output Power and Phase Levels, Simulated Individual and combined Antenna monitoring Input Power and Phase levels, simulated test points, and simulated CSB to SBO Phase.

6. An Instrument Landing System (ILS) Glideslope simulated radiation pattern, control, and monitoring central processing unit comprised of off the shelf computer hardware, a consolidation microcontroller that accepts the outputs of simulator circuits identified claims 4 and 5, custom software that produces an image of the current Localizer operation using Localizer transmitter, distribution unit, and antenna simulator data from the simulator circuits identified in claims 4 and 5, a wireless interface connected to the processor that communicates with a simulated field ILS receiver in order to acquire the vertical angular position of the receiver and then supply a calculated radiation pattern reading back to the simulated ILS receiver position, an internal monitoring custom software feature that represents the internal monitoring of the system using data from the outputs of simulator circuits identified in claims 4 and 5, and a user interface that allows control and viewing of the overall simulator operation.

7. A simulated Instrument Landing (ILS) Localizer field receiver comprised of LASER distance measuring devices, Multiple GPS receivers to calculate and average receiver position, a microcontroller to process LASER and GPS position, a wireless RF transceiver to send the calculated position to the central computer processor and receive corresponding ILS reading data from the central computer processor, a microcontroller to translate ILS position data to a display, a display, and a selector switch to choose readings of RF Level, Difference in Depth of Modulation (DDM), 90 Hz Modulation, 150 Hz Modulation, or 1020 Hz Modulation.

8. A simulated Instrument Landing (ILS) Glideslope field receiver comprised of LASER distance measuring devices, a vertical adjustable simulated antenna, Multiple GPS receivers to calculate and average receiver position, a microcontroller to process LASER and GPS position, a wireless RF transceiver to send the calculated position to the central computer processor and receive corresponding ILS reading data from the central computer processor, a microcontroller to translate ILS position data to a display, a display, and a selector switch to choose readings of RF Level, Difference in Depth of Modulation (DDM), 90 Hz Modulation, 150 Hz Modulation, or 1020 Hz Modulation.

9. A simulated Instrument Landing System test set that connects to simulated test points in at the central processor, a microcontroller to evaluate the point attached to and determine a corresponding output, a display to provide a value of Frequency, Modulation, RF Power, or Phase as appropriate.
